(19) United States
(12) Patent Application Publication
(10) Pub. No.: US 2005/0179955 A1
(43) Pub. Date: Aug. 18, 2005

(54) Graphic element for protecting banknotes, securities and documents and method for producing said graphic element

(76) Inventors: Mikhail Vasilievich Shovgenyuk, Lviv (UA); Vitalii Eugenievich Bilorus, Kyiv (UA); Mikhail Pavlovich Kozlovskii, Lviv (UA); Taras Yevstafievich Krokhmalskii, Lviv (UA)

Correspondence Address: M.V. Shovgenyuk, 14/30, Kavaleridze Str, Lviv, 79066, UA

(21) Appl. No.: 10/779,812

(22) Filed: Feb. 18, 2004

(51) Int. Cl. G06K 15/00; G06K 19/06; B42D 15/00

(52) U.S. Cl. 358/3.28; 235/494; 283/113; 283/902

(57) ABSTRACT

The inventive graphic element for protecting banknotes, securities and documents includes printed encoded image 6 and corresponding key, which are two-dimensional matrices of cells of an ordered aperiodic structure. These images form visible image of graphic element 7 when they are superimposed. A method of manufacturing of said element consists in forming of encoded image and its key on the basis of original image. Encoding is performed by special software, which converts original image into multilevel image, whose each level is globally replaced with a matrix of cells of ordered aperiodic structure. The key is printed inversely on the other side of the protected object precisely matched with the encoded image. Encoded image and its key, which may have different dimensions, are printed in color inks under certain angular orientation.

### BACKGROUND OF THE INVENTION

The invention relates to special kinds of printed matter (banknotes, securities, and documents), in particular, encoding of graphic images, symbols, marks and can be used for protection of a printed matter against counterfeit.

Method of image encoding for protection of securities [WO Application No 9,504,665, pub. 1995] by linear periodic raster-type structures consisting in producing two images with encoded symbols is well known. The first image has the form of two the mutually displaced linear rasters, and the second image, key to the first one, has the form of a linear structure. As a result of their superimposition the encoded image is visualized.

The method of image encoding [U.S. Pat. No. 5,790,703, pub. 1998] is known as well in which the dot periodic raster-type structures are used as encoding elements.

However, all periodic raster-type structures are very sensitive to contours of the original image that does not allow achieving high quality encoding. Besides, such structures can be easily decoded and counterfeited.

The method for protecting visual information using cryptographic watermarks [U.S. Pat. No. 5,488,664, pub. 1996] is selected as a prototype. In this method the graphic element of protection consists of two images in the form of 2-dimensional matrices of the binary cells. The first encoded image is printed on the document and the second image as a key to it, is printed on a transparent film. As a result of fine matching the image on the film and the first encoded image, the visible image of a cryptographic watermark is formed on the object of protection.

Nevertheless, this method for protecting visual information has a series of deficiencies. The encoding of a graphic image is implemented by forming 2-dimensional complementary matrices of cells constructed by using of base matrices 2×2 which look like random structures. Such structures very distort the visible image and are not suitable for producing cryptographic watermarks with fine structure of details, symbols or special marks. At the same time, the rough random structures easily yield to copying. Besides, it is possible to construct a matrix of ordered structure (e.g. quincunx, linear or periodic structure) using matrices 2×2, for which contours of the original image become noticeable.

### BRIEF SUMMARY OF THE INVENTION

Basic idea of the invention consists in achievement of high resolution, decreasing of distortion of a decoded image to ensure reliable identification and high level of copy protection by modification of encoding structure as well as by modification of method of encoded image and its key printing.

Implementation of this idea is achieved by using of graphic element for protection banknotes, securities and other documents. Such an element consists of printed encoded image and its key. These images are two-dimensional matrices of binary cells. Visible image of graphic element is formed under matching these images. According to the invention the encoded image containing information on the original image is formed by global replacement of each level of the multilevel original image with a matrix of cells of ordered aperiodic structure of high resolution. And the key intending for decoding of the encoded image is formed from, at least, one matrix of cells of this ordered aperiodic structure. It is inversely printed on the other side of the protected object and it is precisely matched with the encoded image. Due to that in reflected light encoding matrices of cells of each side are visually similar and are perceived as neutral gray or color homogeneous background. In transmitted light visible image of the graphic element is observed, color of which may differ from visible colors of the encoded image and its key.

An encoded image can include additional encoded images, which are decoded by additional key printed separately. Besides, the same key is used for decoding different encoded images of a graphic element.

Implementation of this idea is also achieved by, according to the invention, that encoding is performed with the use of special software. This software converts an original image into a multilevel graphic image. Each level of this image is globally replaced with a matrix of cells of ordered aperiodic structure. Corresponding key is printed inversely on the other side. It is precisely matched with encoded image. The encoded image and its key, which may have different dimensions, are printed in color inks on the protected object with certain angular orientation.

According to the invention the matrices of cells of ordered aperiodic structure are constructed using the Kronecker multiplication method from base orthogonal Hadamard matrices of dimension 4×4 or more. Whose 50% of elements are equal to +1 and 50% of elements are equal to −1, with the further rearrangement of rows, columns or separate fragments of the matrix of cells for generating different types of encoding structures.

A two-level graphic encoded image is formed by replacement of both levels of the original graphic image with a matrix of cells of the complementary ordered aperiodic structures of 50% area coverage. To form enlightened encoded image area coverage of the matrix of cells of the two-level encoded image is reduced by withdrawal of the certain part of dark cells.

A three-level graphic encoded image is formed by replacement of two levels of the original graphic image with matrix of the complementary cells, and the third level of the original graphic image is replaced with matrix of cells of partially complementary ordered aperiodic structure.

Besides, according to the invention:
The encoded image and its key are printed with resolution greater and not multiple to resolutions of copy machines;
The encoded image and its key are printed in special color printing inks of two complementary or partly complementary colors;
The encoded image is printed in color printing ink reflecting light in one of three ranges of visible spectrum, on color background reflecting light in two other ranges of visible spectrum, and the key is printed in color or neutral gray ink constituted of colors of synthesis;
The encoded image is printed in color printing ink on white background reflecting light in one of three ranges of visible spectrum, and the key is printed in color ink on white background reflecting light in other ranges of visible spectrum;
The encoded image and its key are printed on background of visible unilateral or bilateral matched graphic image to form additional elements of the visible image, special marks or symbols for additional protection;
The encoded image and its key are printed on paper with a light watermark, which is additionally processed by agent to increase its transparency, or on a film.

Using a matrix of cells of ordered aperiodic structure enables to encode an image with high resolution, that, in turn, enables to identify more precisely the visible image. Besides, such structures under attempt of copying in the digital format, owing to difference of structures offered in the invention and included in software of copy equipment, are essentially distorted. Printing matrix of cells of the key inversely on the other side of the protected object, under precisely matching it with matrix of cells of the encoded image, enables to identify promptly and reliably the visible image in transmitted light. In reflected light a visible image is absent and matrix of cells of ordered aperiodic structure is observed as homogeneous gray or color background. Fundamental difficulties arise at attempt of copying of an object of protection. To watch visible decoded image, it is necessary precisely to match the encoded image and its key that is practically impossible to achieve because of their visual identity in reflected light and because of absence of any features of the original image. Besides, modern copying equipment does not enable to perform simultaneously two-side printing. At successive printing at first on one side and then on the other side of the protected object, it is impossible technically to achieve fine matching of two different images. As a result of such a copying of an object of protection at inexact matching of the encoded images with their key quality of the decoded image essentially decreases or such an image is not observed at all.

According to the invention, achieving necessary condition of exact matching encoded images under copying is complicated by the method described above. Namely, at the stage of image encoding and the manufacturing of a key, the encoding structures are shifted on arbitrary chosen quantity of rows and columns, or the encoded image and its key are divided into some fragments which are printed on different sites of an object of protection. These sites are known only for its producer. Therefore to counterfeit the encoded image and its key, and also precisely match them, is practically impossible.

The printing of an encoded image and key of different dimensions or under certain angle on two sides of an object of protection technically complicates their matching at the counterfeit as well.

### BRIEF DESCRIPTION OF THE SEVERAL VIEWS OF THE DRAWING

FIG. 1: constitution of the graphic element;

FIG. 2: schemes of observation of encoded and decoded images on a protected object;

FIG. 3: two-level and three-level original images;

FIG. 4: examples of base matrices 4×4;

FIG. 5: encoded two-level image;

FIG. 6: key to the encoded two-level image;

FIG. 7: decoded two-level image;

FIG. 8: light encoded two-level image;

FIG. 9: light decoded two-level image;

FIG. 10: encoded three-level image;

FIG. 11: decoded three-level image;

FIGS. 12, 13: schemes of forming the color image of a graphic element;

FIG. 14: fragment of the encoded image and the result of its copying with smaller resolution.

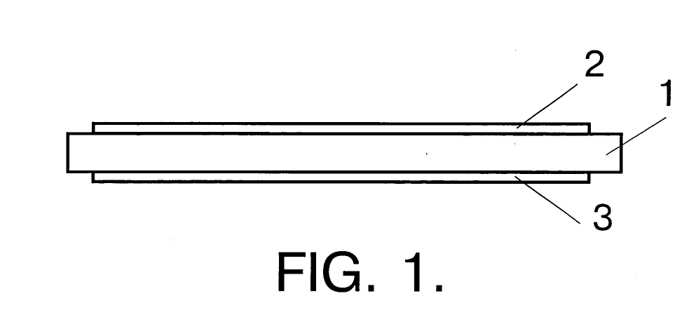

### DETAILED DESCRIPTION OF THE INVENTION

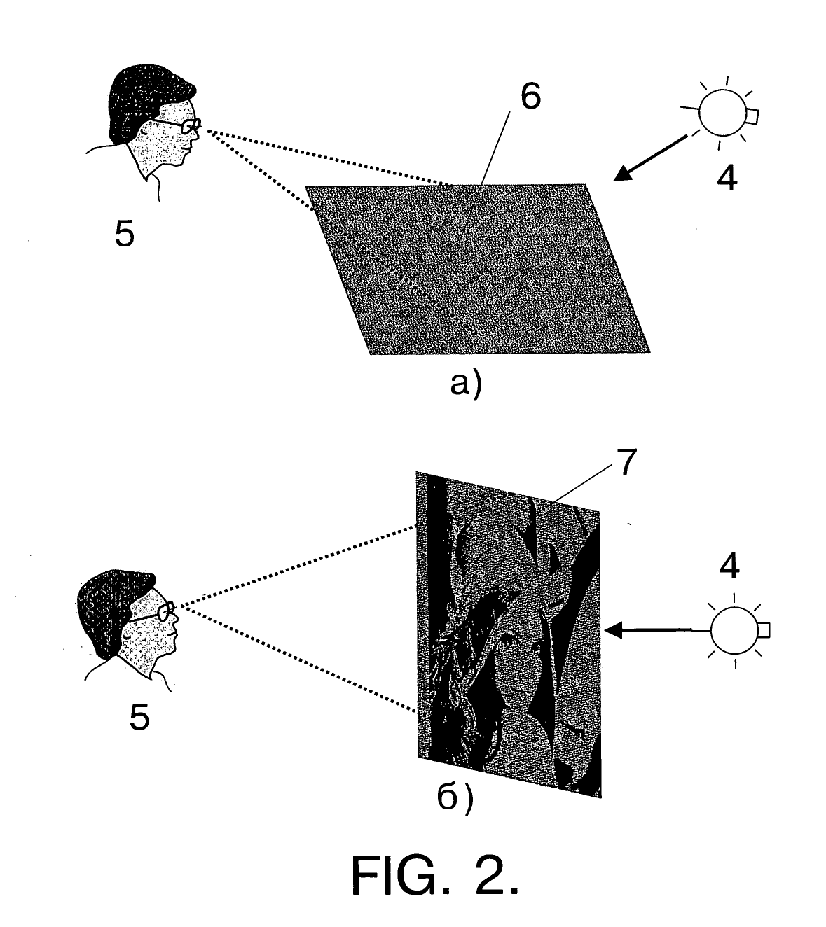

The graphic element of protection of banknotes, securities, documents consists of encoded image 2 and its key 3 which are 2-dimensional matrices of binary cells, and which being matched form the visible image of the graphic element, printed on object of protection 1. Encoded image 2 containing the encoded information on the original image is formed by global replacement of each level of the multilevel original image with a matrix of cells of ordered aperiodic structure of high resolution. Key 3 intending for image decoding, is formed at least from one matrix of cells of this ordered aperiodic structure. It is printed inversely on the other side of object of protection 1 and is precisely matched with encoded image 2. Consequently, in reflected light of source 4 (FIG. 2a) the encoding matrices of cells of each side of protected object 1 are visually similar and are perceived by expert 5 as neutral gray or color homogeneous background 6. In transmitted light (FIG. 2b) visible image 7 of a graphic element is observed, the color of which may differ from visible colors of encoded image 2 and key 3. For expert 5 it is a confirmation that the document is genuine.

Encoded image 2 can include additional encoded images, which are decoded by additional key printed separately. Besides, in the proposed invention the same key can decode different encoded images of a graphic element.

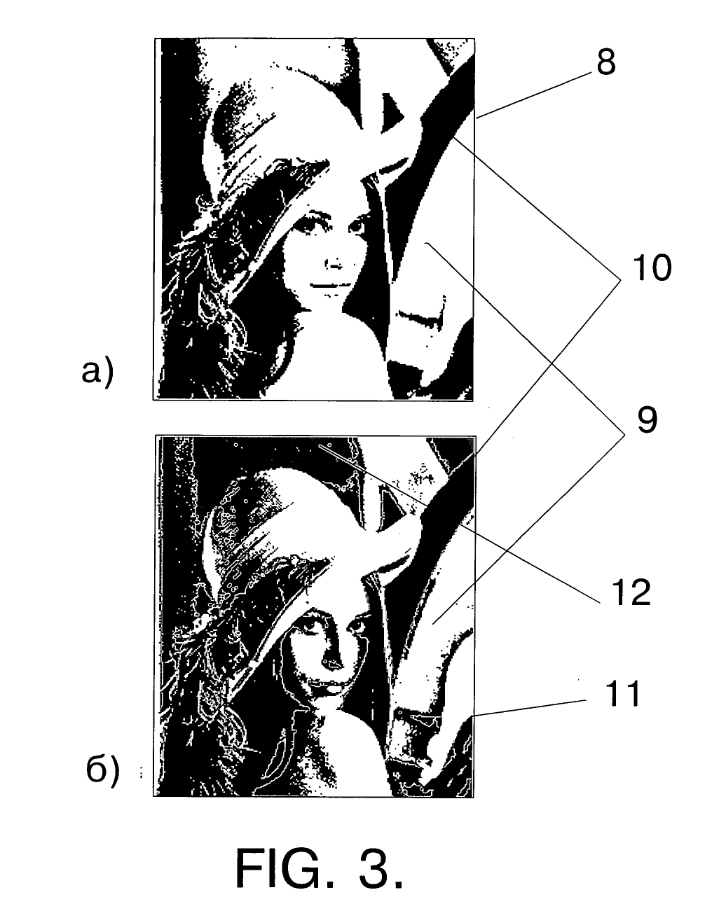

The method of manufacture of a graphic element is based on the principle of graphic image encoding by a matrix of binary cells of ordered aperiodic structure. On an initial stage of encoding with the help of special software the global binarization of an original half-tone image is realized. Any original half-tone image obtained by photographing with the help of a digital camera or scanning of the image, is recorded in digital format with resolution R and represented by a matrix A=[aₙₘ] of dimensions N×M where N=Ra, M=Ra, a and b are linear dimensions of the image. Each element aₙₘ of the image is characterized by value of intensity Iₙₘ changing from 0 up to 255 in the gradations of gray color or colors of synthesis. The reading of values of intensity Iₙₘ of all elements aₙₘ of images is fulfilled. The mean threshold value of intensity I_{MED} is introduced. The following algorithm forms two different intensities. If for element under analysis aₙₘ the relation Iₙₘ≦I_{MED} takes place, for this element value 0 is set, and if Iₙₘ>I_{MED}, for such an element value 1 is set. So, two-level image 8 (FIG. 3a) with first level 9 and, accordingly, second level 10 is obtained. As a result of change of the threshold value I_{MED} such a two-level image 8 is chosen, which as much as possible represents typical features and details of an original half-tone image.

Similarly by global binarization three-level image 11 (FIG. 36) is formed. In this case the two threshold values of intensity I_{MED1} and I_{MED2} are introduced. Value 0 is set for areas of image whose intensities are Iₙₘ<I_{MED1} Accordingly, value S is set for areas of image with intensities I_{MED1}<Iₙₘ<I_{MED2}; and value 1 is set for areas with Iₙₘ>I_{MED2}. Presence of areas corresponding to an intermediate level 12 gradation essentially improves the quality of three-level binary image 11 as compared with two-level image 8.

Similarly the multilevel two-level image is formed which with magnification of quantity of levels will come nearer ever more to halftone. In most cases, for problems of encoding of optical information quality of three levels encoding is sufficient.

Encoding of the original image is fulfilled by a principle of global replacement of levels of the multilevel binary image with a matrix of cells with ordered aperiodic structure. On the encoded image different levels are filled with a matrix of cells of the relevant ordered aperiodic structure, which ensures a visual indistinguishability of contours of this image. For image decoding, the key is formed, which contains one of encoding structures of the encoded image. As a result of matching the key with the encoded image the complementary base matrices of cells of two encoding structures are overlapped proportionally to depth of the level and, thus, the original image is recovered.

For image encoding ordered aperiodic structures are used which are constructed on the basis of orthogonal Hadamard matrices of dimension 4×4 or more. The class of orthogonal Hadamard matrices 4×4 is chosen for which 50% of elements possess value +1, and 50% of elements possess value −1. For each such an orthogonal matrix H₄(n;m) according to the following relation
H₄(n;m)=exp[iπA₄(n;m)] (1)
the corresponding base encoding matrix A₄(n;m) is constructed. All Hadamard matrices H₄(n;m) are characterized by fundamental property of an orthogonality of all their rows and columns. And, the property of orthogonality is maintained at arbitrary transpositions of rows and columns and also at multiplication of arbitrary rows or column by −1. By transpositions only of rows or columns of one Hadamard matrix H₄(n;m) 4!=24 new Hadamard matrices are obtained. By multiplication of each row or column of new Hadamard matrices by −1, large quantity of different base matrices A₄(n;m) 4×4 are obtained for image encoding. All new matrices have a common regularity: two arbitrary rows or two columns differ and have equal quantity of identical and different elements. All matrices A₄(n;m) are ordered and aperiodic.

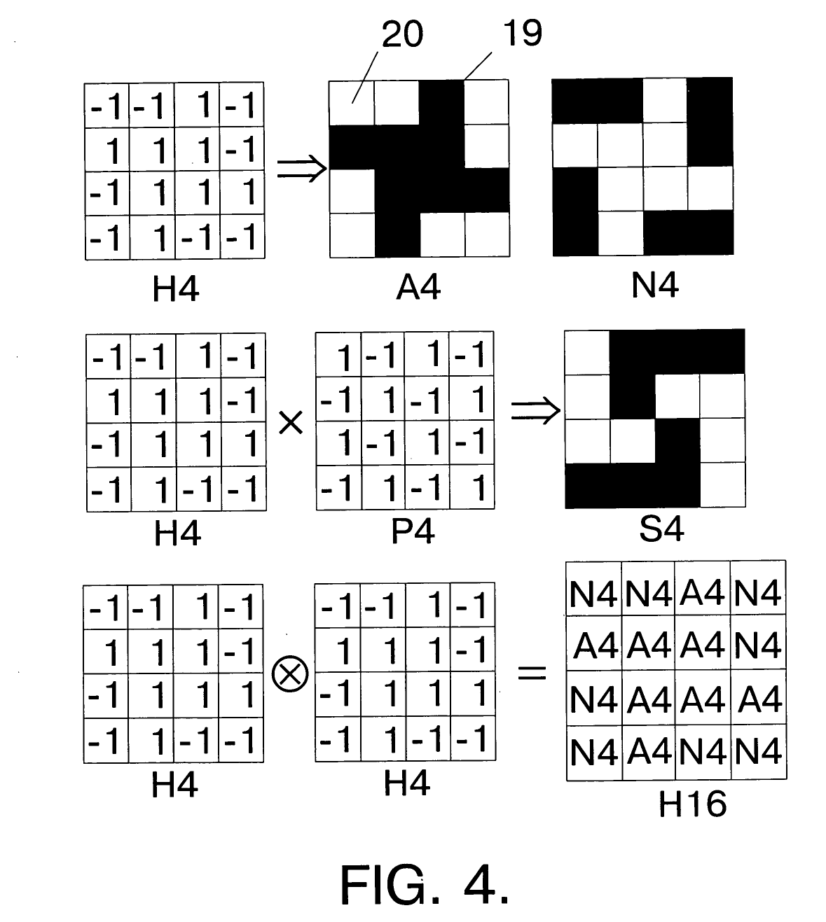

The typical X-shaped orthogonal Hadamard matrix H4 is presented on FIG. 4. Base matrix A4 of dimension 4×4, in which all rows and columns are different, constructed by relation (1) is presented on FIG. 4 as well. Multiplication of an orthogonal matrix H4 by −1 is equivalent to the construction of a base matrix N4 complementary to A4. An important property of orthogonal Hadamard matrices that is used in this invention is the construction of a new orthogonal matrix with the help of elementwise multiplication of an orthogonal matrix by a periodic matrix, the elements of which are +1 or −1. On FIG. 4 the case of elementwise multiplication of an orthogonal matrix H4 by a periodic matrix P4 is presented. As a result of such a multiplication, a new base matrix S4 is obtained, which, though differs from a matrix A4 by transpositions of even and odd rows, is reduced to it.

To construct matrices of higher dimensions the operation of the Kronecker multiplication of several orthogonal Hadamard matrices is used
H_{M}(n;m)=H₄⁽¹⁾(n;m)\mathring{×}H₄⁽²⁾(n;m)\mathring{×} . . . . . . \mathring{×}H₄^{(K)}(n;m), (2)
where \mathring{×} is the symbol of the Kronecker multiplication. As a result of multiplication of two Hadamard matrices 4×4, a Hadamard matrix of dimension 16×16 is obtained. On FIG. 4 an example of the Kronecker product of two Hadamard matrices H4 is presented, as a result an encoding matrix H16 of dimension 16×16 is constructed from base matrices A4 and N4. Further, after multiplication by the third Hadamard matrix 4×4, a Hadamard matrix of dimension 64×64 is obtained etc. By multiplication of K Hadamard matrices a Hadamard matrix of dimension 4^{K}×4^{K} is obtained, and in the case when all K matrices are equal to each other, by relation (2) the Kronecker degree of K order is obtained. Thus, using base Hadamard matrices 4×4, by relation (2) the matrices of necessary dimension are formed. All such new matrices, as well as the base matrices, are ordered and aperiodic.

It is possible to choose a class of Hadamard matrices 8×8 as base matrices as well. To construct such a matrix it is enough to compute the Kronecker product by relation (2) H₈(n;m)=H₄(n;m)H\mathring{×}H₂(n;m) where H₄(n;m) is an arbitrary matrix of the class of base Hadamard matrices 4×4, H₂(n;m) is a Hadamard matrix 2×2. The base Hadamard matrices of dimension 8×8 may be constructed without using the Kronecker multiplication as well. The higher is dimension of the base matrices, the larger is quantity of different combinations of transpositions of rows and columns and multiplication theirs by −1 and, accordingly, the larger is the class of base encoding matrices.

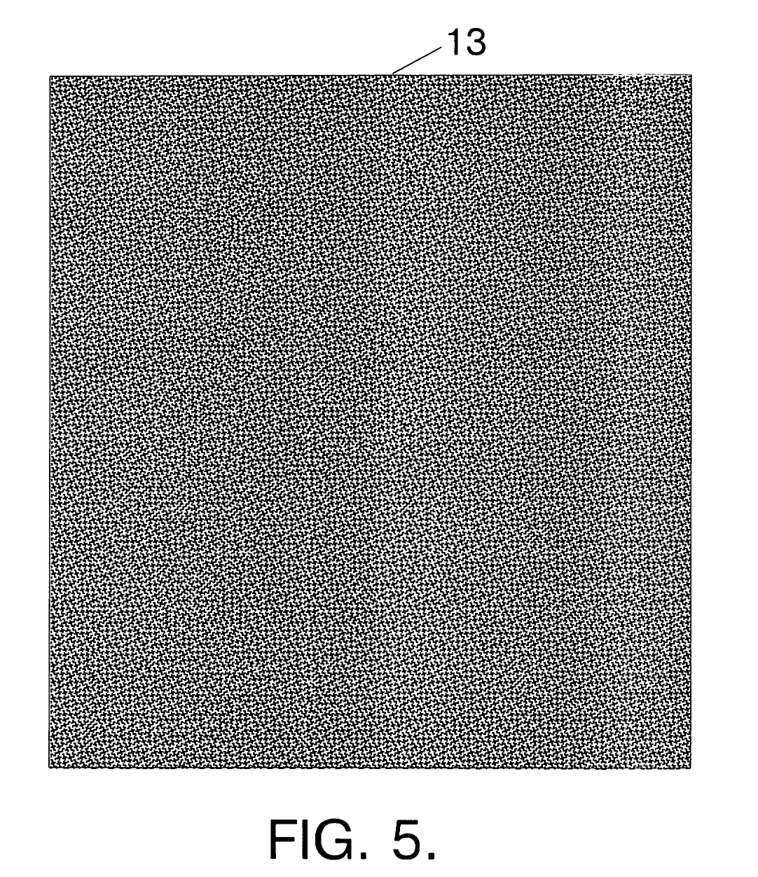

The method of encoding of a two-level image on the basis of matrices of cells of ordered aperiodic structure consists in following. Binary image 8 has dimension of 227×255 elements. For encoding of this image a base orthogonal Hadamard matrix H4 is chosen. For a complete overlap of all elements aₙₘ of the binary image, an orthogonal matrix of Hadamard H1024 of dimension 1024×1024 is constructed by relation (2) which is the fifth Kronecker degree of a base matrix H4. For this orthogonal matrix by relation (1) an encoding matrix A1024 and the corresponding complementary matrix N1024 of dimension 1024×1024 are obtained. Level 9 is globally replaced with the ordered aperiodic matrix A1024, and level 10 is replaced with the matrix N1024. Encoded two-level image 13, obtained by such a global replacement of two levels with ordered aperiodic structures, is given on FIG. 5. On encoded two-level image 13 all contours of binary two-level image 8 become invisible. Due to the fact that structures of encoding matrices are aperiodic, no details or fragments of binary two-level image 8 are visible on the encoded image.

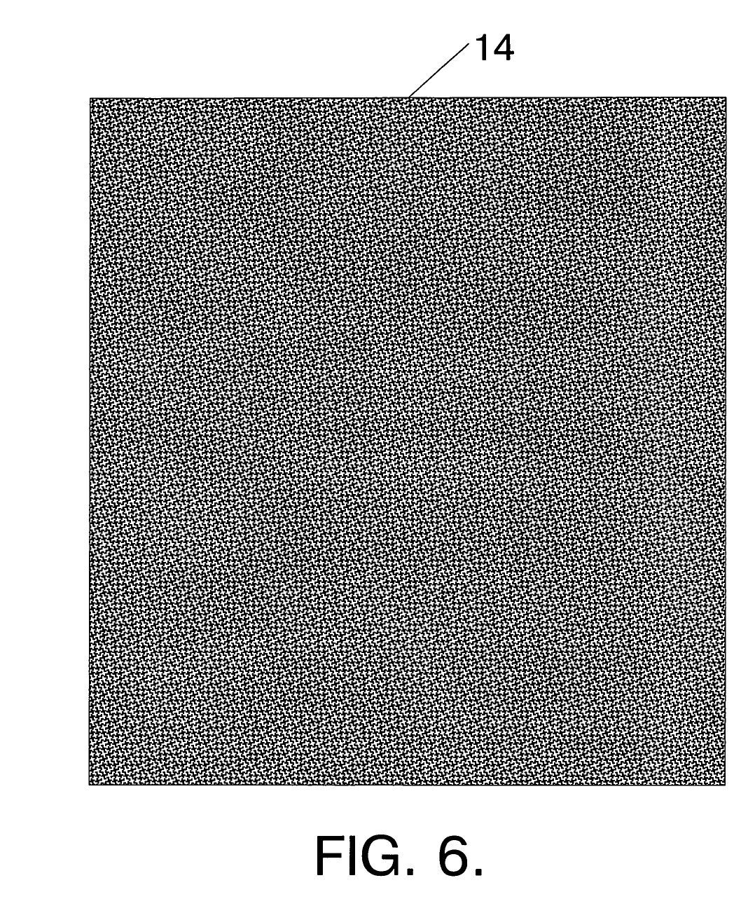

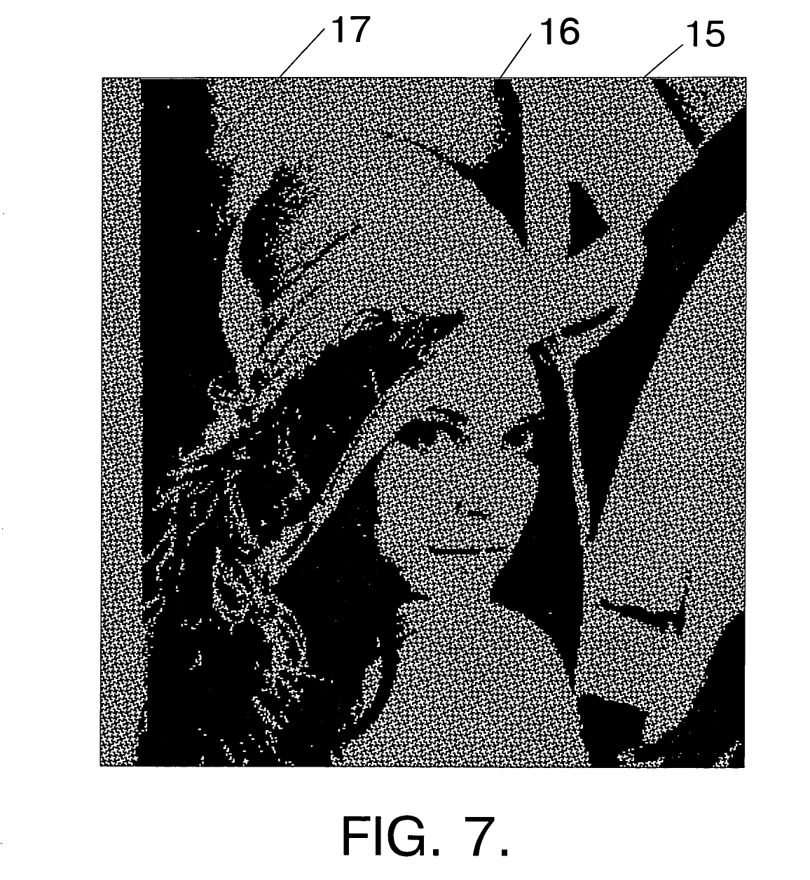

Key 14 of encoded two-level image 13, presented on FIG. 6, is formed by one matrix A1024 of ordered aperiodic structure. As a result of matching of encoded two-level image 13 with key 14 decoded two-level image 15 is formed which is given on FIG. 7. The method of decoding of this image consists in following. Each area of level 9 on encoded image 13 is encoded by the base matrix of cells A4, which is located on key 14 as well. As a result of superimposing of encoded two-level image 13 and key 14, corresponding elements of the matrix A4 are overlapped, owing to that on level 9 the ordered aperiodic structure 16 is formed corresponding to encoding structure of key 14 and is characterized by 50% area coverage. Level 10 on decoded two-level image 15 is formed by other scheme. Each area of encoded image 13, which is encoded by a complementary matrix of cells N4, is overlapped on a base matrix of cells A4 of key 14. As a result, level 10 on decoded two-level image 15 is formed as solid background 17 of 100% area coverage. The presence of this background ensures high contrast of decoded image 15, which exactly reconstructs all details of a binary two-level image 8.

By sole key 14, which does not contain any details of encoded image 13, different images encoded in such a way, are decoded. By other key the encoded images can not be decoded, though visually all keys are similar. For construction of keys of dimension 1024×1024 there are at least 24 versions of base matrices. More than 24⁵≈8×10 of different keys can be obtained from five arbitrary matrices by using relation (2) for Kronecker product.

By the proposed method different graphic elements are encoded, including text or graphic symbols which are decoded by a common or personal key. The quantity of keys can be increased. If a key from a matrix of cells is formed with ordered aperiodic structure N1024, as a result of matching such a key with encoded image 13 a negative two-level image is decoded, as the forming levels 9 and 10 changes places. The construction of more composite key is possible in which one arbitrary chosen part of area of a key contains an encoding matrix A1024, and the second part of area of a key contains a encoding matrix N1024. On a key the border of two encoding matrices is inconspicuous. Nevertheless, at matching of such a key with encoded two-level image 13 the fragments of the negative and positive images will be decoded.

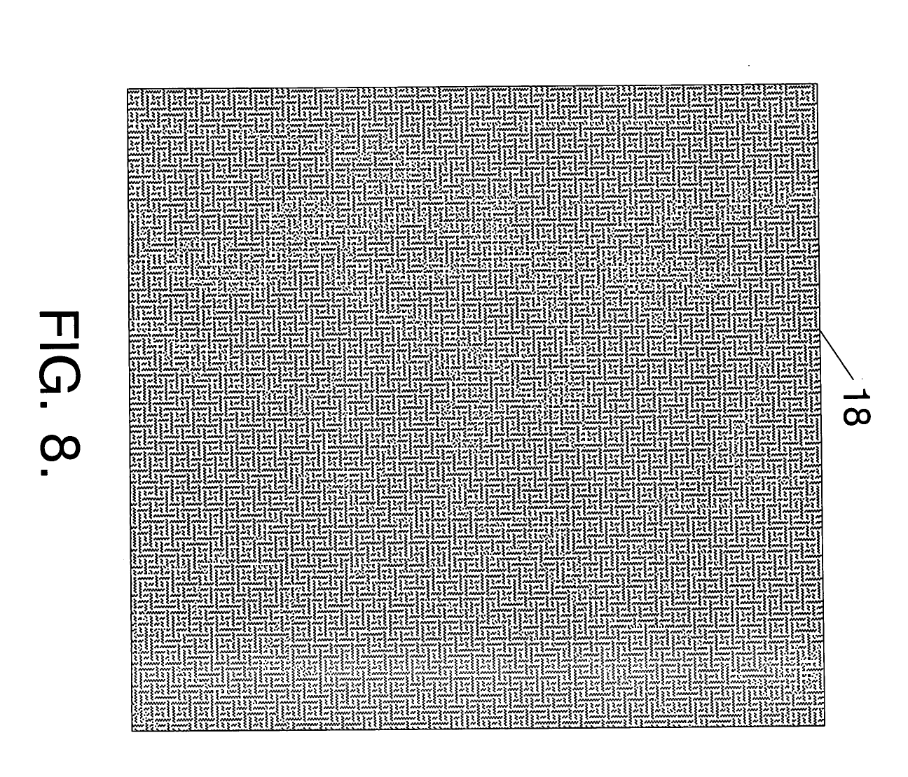

A method of forming light encoded image 18 (FIG. 8) consists in withdrawing of part of dark cells 19 from the encoded image and from the corresponding key. For example, a matrix of cells of ordered aperiodic structure S1024 constructed by the rule of the Kronecker degree of the fifth order from base matrix S4 is chosen for level 9 and, accordingly, the complementary matrix of cells M1024 is chosen for level 10. Periodic withdrawing of 50% of dark cells 19 from these structures is realized in the following way. The base matrices A4 are chosen and the Kronecker product A4(n;m)\mathring{×}E256(n;m) is evaluated by relation (2), where E256(n;m) is a unit matrix of dimension 256×256, all elements of which are equal to +1. As a result of such a multiplication a periodic matrix P1024 of dimension 1024×1024 is obtained from the base matrices A4. The matrices of encoding structures S1024 and M1024 are multiplied by the rule of elementwise multiplication by the periodic matrix P1024. As the periodic matrix P1024 contains 50% of cells whose values are equal to 0, as a result of elementwise multiplication (1×0=0), light cells 20 (value 1) of encoding structures S1024 and M1024 become dark 19 (value 0). And, accordingly, as a result of multiplication (0×0=0) dark cells 19 of these structures remain dark. Further new encoding matrices K1024 and L1024 are constructed by a rule: K1024=E1024−S1024; L1024=E1024−M1024. It means that as a result of multiplication by the periodic matrix P1024 and further subtraction from the unit matrix E1024 50% of dark cells 19 are periodically withdrawn from encoding structures S1024 and M1024, and accordingly, light encoding structures K1024 and L1024 containing 75% of light cells are constructed.

An example of light encoded two-level image 18 is presented on FIG. 8 in which level 9 of binarized two-level image 8 is globally replaced with light aperiodic structure K1024, and level 10 is replaced with light aperiodic structure L1024. As can be seen, such light aperiodic structures K1024 and L1024 have a typical form of a maze. On light encoded two-level image 18 contours or features of two-level image 8 are visually inconspicuous as well.

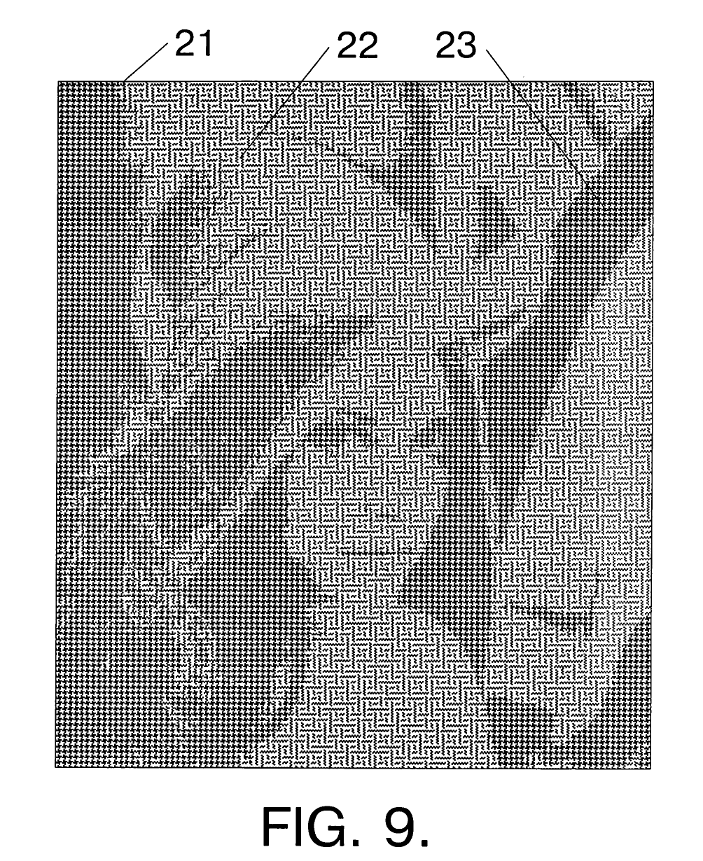

Further, a key is constructed from encoding structure K1024. As a result of matching of such a key with light encoded image 18, light decoded image 21 is obtained which is shown on FIG. 9. In this case light aperiodic structure 22, which accords with a key, is characterized by 25% area coverage, corresponds to level 9, and periodic quincunx structure 23 of 50% area coverage corresponds to level 10. As these two structures are different, two gradations are clearly separated on light decoded image 21.

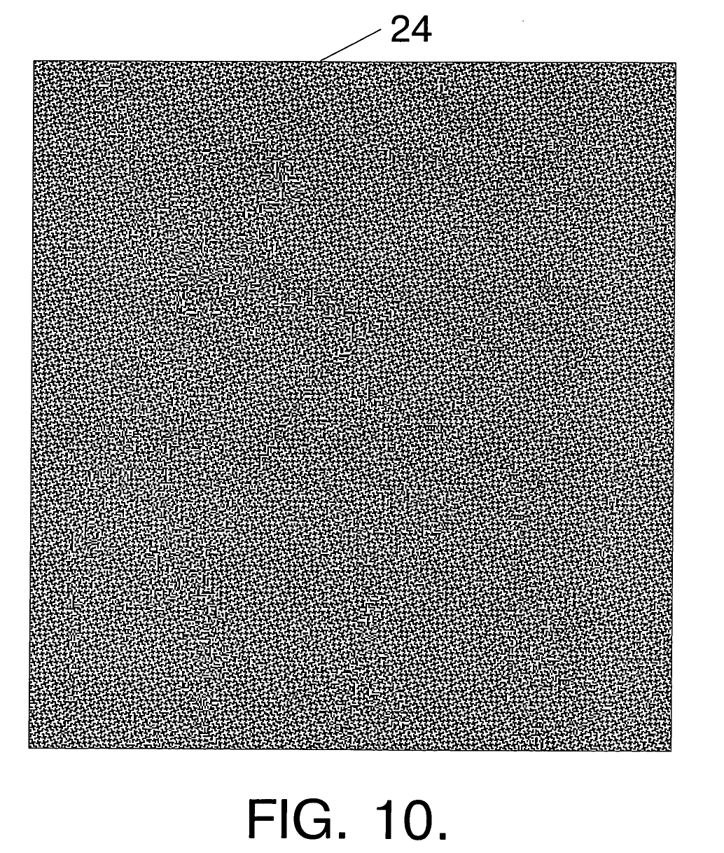

To improve quality of image encoding the method of encoding of three-level binary image 11 is implemented. On FIG. 10 encoded three-level image 24 is presented in which an intermediate level 12 is globally replaced with ordered aperiodic structure S1024. This structure is formed as the Kronecker degree of the fifth order from base matrices S4; and levels 9 and 10 are formed by the method of encoding of a two-level image as described above. For such a three-level image encoding method any features, fragments or contours of three-level image 11 are visually inconspicuous as well.

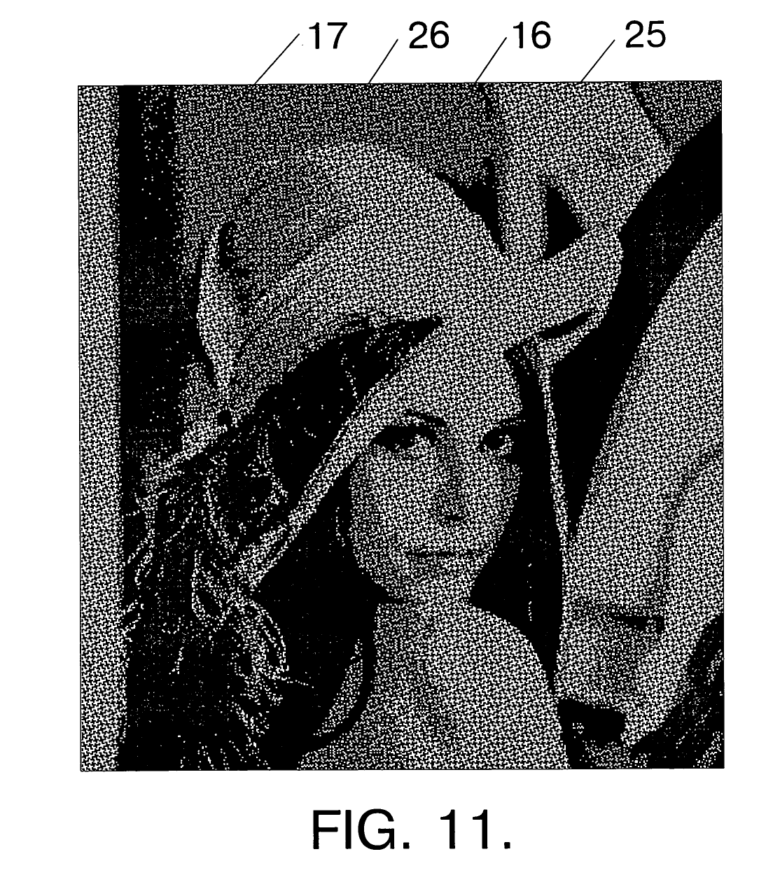

Decoded with the help of key 14 three-level image 25 is presented on FIG. 11. After decoding of level 9 and level 10, structure 16 and dark background 17 are obtained analogously to the case of two-level image 15 decoding. Level 12 of decoded three-level image 25 is formed as a result of partial overlap of encoding structures S1024 and A1024, owing to that the ordered aperiodic structure 26 arises which is characterized by 75% area coverage and is visually similar to structure 16. As can be seen, the presence of level 12 essentially improves the quality of decoded three-level image 25 as compared with analogous two-level image 15.

Graphic element of protection is obtained by printing encoded image 2 on one side of object of protection 1 and key 3 is printed on the other side in color, these images are precisely matched.

Specialized printing equipment for manufacturing of protected production allows printing two-sided images with high accuracy of matching. Taking into account that level 10 of decoded images (FIGS. 7, 11) is formed as solid dark background 17, under printing on a paper, despite of light dispersion in width of a paper, in transmitted light (FIG. 2b) visible decoded image 7 of graphic elements is clearly observed. To improve contrast of decoded image 7 a paper is additionally processed by agent, which diminishes the light absorption in a paper and increases its transparency. In the case of printing of encoded image and its key on both sides of a film, the method of graphic element of protection manufacturing ensures high contrast of decoded image 7 in transmitted light.

For making additional elements of protection, an encoded image is printed on a background of visible graphic image and its key is printed on the other side of protected object. Or an encoded image and its key are printed on both sides in the combination with the bilateral matched visible graphic images of an object of protection.

Printed in color inks on object of protection 1 encoded image 2 and its key 3 in reflected light are visually perceived by expert 5 as homogeneous background 6 looking like neutral gray or typical color. In transmitted light they are perceived as decoded color image 7 whose colors do not coincide with colors of encoded image 2 and key 3. The change of color of a graphic element in reflected and transmitted light is an additional protection.

Let us describe in more details the mechanism of forming of decoded color image and results of copying of the encoded image printed in color printing inks and its key.

The matrix of cells of ordered aperiodic structure of encoded image 2 and its key 3 with 50% area coverage, has a peculiar property. If light cells 20 of encoding matrix are printed on object of protection 1 in printing ink which absorbs light in one range of visible spectrum and reflects light in two other ranges, and if dark cells 19 are printed in printing ink of other color, which absorbs light in two other ranges of visible spectrum and reflects light in another range, then such a structure is visually perceived as 50% neutral gray background. For example, light cells 20 are printed in yellow (Y) color which absorbs light in blue (B) range and reflects light in green (G) and red (R) ranges of spectrum. Dark cells 19 are printed in complementary blue (B) color, which, to the contrary, reflects light in blue (B) range and absorbs light in green (G) and red (R) ranges of spectrum. In such a way printed encoded image 2 and its key 3 on object of protection 1 is visually perceived by expert 5 as 50% neutral gray background, because in reflected light there are all three ranges of visible spectrum which form its whole range.

Other methods of printing of color encoded image 2 and its key 3 are possible. For example, light cells 20 are printed in magenta (M) color, which absorbs light in green (G) range and reflects light in blue (B) and red (R) ranges of spectrum, and dark cells 19 are printed in complementary green (G) color. Or light cells 20 are printed in blue (B) color which absorbs light in red (R) range and reflects light in blue (B) and green (G) ranges of spectrum, and dark cells 19 are printed in complementary red (R) color.

Such methods of color printing of encoded image 2 and its key 3 can be easily implemented technically. As the printing inks of color synthesis do not correspond to ideal spectral characteristics, printed such a way encoded image 2 and its key 3 are accepted visually as similar to neutral gray background.

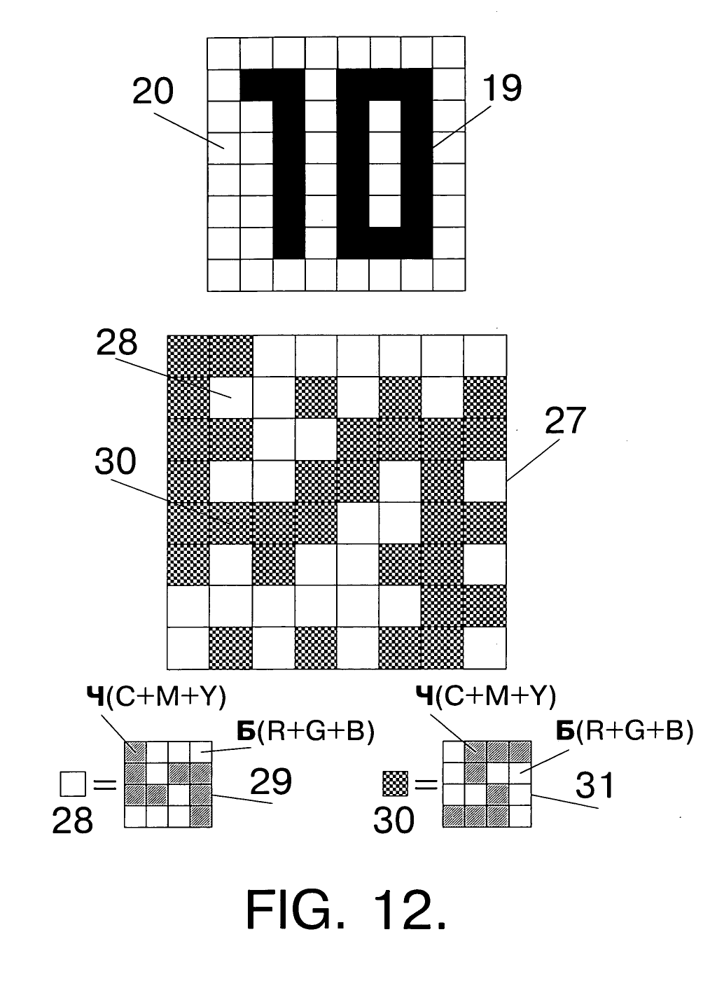

The forming of a color decoded image is explained on an example of encoding of number “10” which is constructed from dark cells 19 on the area of light cells 20 of matrix 8×8 (FIG. 12). To form a base matrix H8 of dimension 8×8, a matrix of Hadamard H4s is chosen from the class of base matrices 4×4 by relation (1). It corresponds to the base encoding matrix S4, and it is multiplied by Hadamard matrix H2 by the rule of Kronecker multiplication (2). Further, as a result of the Kronecker multiplication of base matrix H8 by matrix H4s the matrix of cells of key 27 with ordered aperiodic structure is obtained. Some cells 28 of this matrix are constructed from base matrices of cells 29, and other cells 30 are constructed from complementary base matrices of cells 31. A key of encoded image 27 of number “10” are printed on a white background on one side of an object of protection 1 in black (B) color constituted of equal parts of colors of synthesis: cyan (C), magenta (M), and yellow (Y). In reflected light the key 27 is visually perceived as neutral gray background 6.

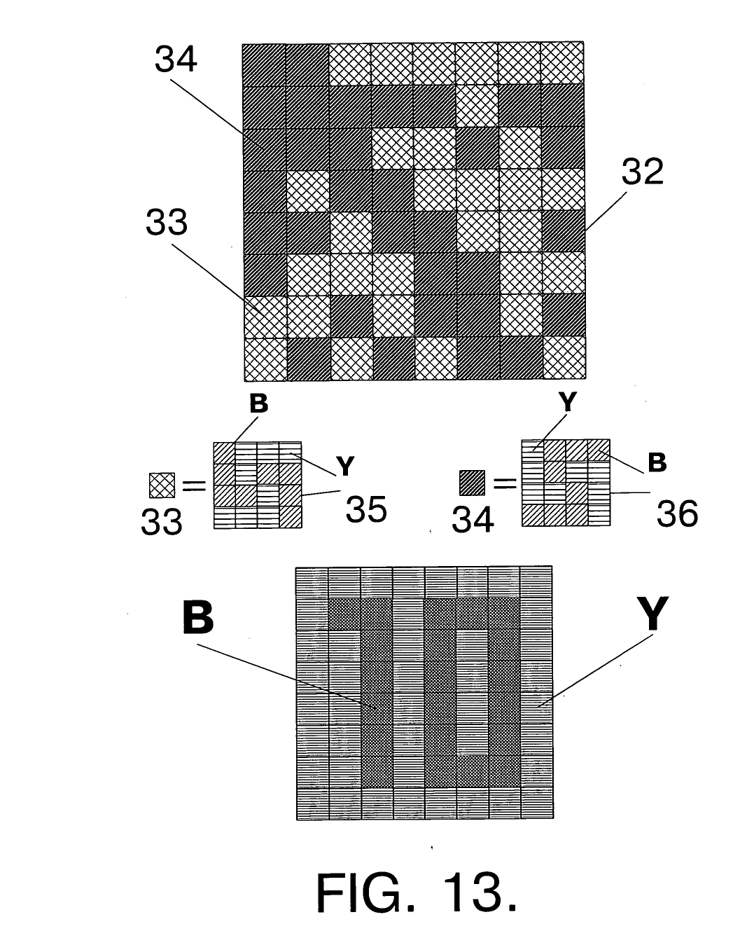

The matrix of cells of encoded image 32 of numbers “10” which is shown on FIG. 13 is constructed from cells 33 and 34. Cell 33 is constructed from a base matrix of cells 35 and, accordingly, cell 34 is constructed from a complementary matrix of cells 36. Encoded image 32 is printed on a yellow (Y) background on the other side of an object of protection 1 in blue (B) printing ink. In reflected light encoded image 32 visually is perceived as neutral gray background as well, as yellow (Y) background reflects green (G) and red (R) of ranges of visible spectrum, and the ink reflects the third, blue (B), range of visible spectrum.

In transmitted light under matching encoded image 32 and key 27, the forming of the color decoded image takes place by other schema. For all light cells 20 the matching of base matrices of cells 28 and 33 and, accordingly, of base matrices of cells 30 and 34 takes place. As a result of it the blue (B) the color of encoded image 32 is overlapped by black (B) color of key 27 and in transmitted light the yellow (Y) background is observed. For all dark cells 19, to the contrary, matching base matrices of cells 28 and 34 and, accordingly, base matrices of cells 30 and 33, takes place. In this case, the yellow (Y) background of encoded image 32 is overlapped by black (B) color of key 27, and as a result in transmitted light blue (B) color is visualized. Thus, in transmitted light the visible image of number “10” of blue (B) color on the yellow (Y) background will be decoded.

The method of printing of a graphic element of protection in color printing inks is possible. In this case encoded image 32 is printed on a white background of an object of protection 1 in blue (B) printing ink, and key 27 is printed on a white background on the other side of an object of protection 1 in red (R) printing ink. Then for all dark cells 19 as a result of matching base matrices of cells 28 and 34 and, accordingly, base matrices of cells 30 and 33 in transmitted light magenta (M) color is visualized which in reflected light is absent on encoded image 32 and its key 27.

Other methods of printing graphic element of protection are possible when encoded image 32 and its key 27 are printed in special color printing inks of different spectral characteristics.

With the purpose of increasing degree of copy protection, an encoded image and its key are formed using specialized software which allows to set value of resolution R_{cod} which is chosen greater and not multiple to value of resolution R_{copy} of the copy machine.

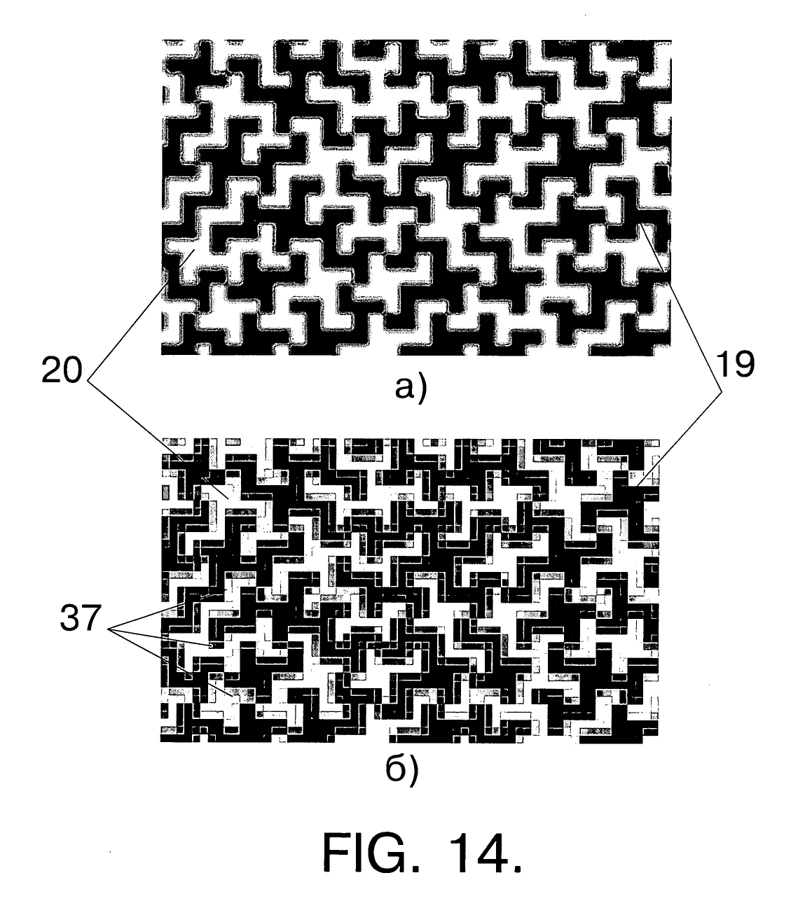

On FIG. 14a an enlarged fragment of encoded two-level image 13 is shown which is manufactured with resolution R_{cod}=2540 dpi. As can be seen, the initial aperiodic encoding matrix consists only of light 20 and dark 19 square cells. If the value of resolution R_{cod} of matrices of cells of two-level encoded image 13 is equal to the value of resolution R_{copy} of the copy machine, or is multiple to this value, such an encoding matrix can be copied without any distortion and loss. In the case if the resolution R_{cod} of encoded two-level image 13 is more than the resolution R_{copy}, such an encoded image is reconstructed by a copy machine as a distorted 50% gray homogeneous background.

On FIG. 14b an example of forming gray background, for the case when resolution of the copy machine is equal to R_{copy}=300 dpi, is presented. As can be seen, owing to a disparity of resolution values R_{cod} and R_{copy}, besides light cells 20 and dark cells 19, square cells 37 in gradations of gray are formed. As a result of copying the structure of encoded image 13 is essentially distorted.

As a result of scanning of an encoded image and its key which are printed in color inks, at the stage of color analysis any of color-separated images will experience essential distortions, where additional square cells 37 are formed in gradations of synthesis colors. Under superimposing of the color-separated images in base colors of synthesis, the structure of encoded image 13 will experience additional distortions. If the encoded by such a structure image be printed, using the copy machine, on an object of protection 1, it is more distorted. Because in digital format the 50% color homogeneous background will be reproduced by using standard software of digital screening of this copy machine, which essentially differs from the encoding ordered aperiodic structure offered in this invention. In the case of using software of digital screening of a periodic structure, encoded image 2 and its key 3 will be printed with using of a periodic raster, owing to that the structure of a matrix of cells will completely be distorted. Accordingly, in transmitted light quality of decoded visible image 7 will worsen. The similar distortions of structure of a matrix of cells will be in the case of using software of stochastic screening as well.

Thus, due to an opportunity of choosing of resolution value R_{cod}, which is known only to a producer, according to proposed method the conditions are achieved under which encoded image 2 and its key 3 are essentially distorted if copied. That leads to partial or complete losses of visible decoded image 7 of a graphic element of protection.

1. A graphic protection element of banknotes, securities, documents which consists of: the printed encoded image containing the encoded information about the original image and which is generated by global replacement of each level of the multilevel original image with the matrix of cells which has an ordered aperiodic structure of high resolution; the printed key of the encoded image which is intended for its decoding and is formed, at least, from one matrix of cells of this ordered aperiodic structure, inversely printed on the other side of the protected object and precisely matched with the encoded image therewith in reflected light encoding matrices of cells on both sides of the protected object are visually similar and are perceived as neutral gray or color homogeneous background, and in transmitted light the visible image of the graphic element, which color may differ from visible colors of the encoded image and the key, is observed.

2. A graphic element according to claim 1 in which the printed encoded image and the printed key of the encoded image are 2-dimentional matrices of binary cells.

3. A graphic element according to claim 1 in which printed encoded image is superimposed over the printed key of the encoded image to form the visible image of a graphic element.

4. A graphic element according to claim 1 in which the encoded image includes additional encoded images, which are decoded by a separately printed additional key.

5. A graphic element according to claim 1 in which the same key is used for decoding different encoded images of the graphic element.

6. A method of manufacturing of a graphic element for protection of banknotes, securities, documents, the method consisting of encoding, i.e. encoded image and its key image are formed on the basis of original image using special software, which converts an original image into multilevel graphic image whose each level is globally replaced with corresponding matrix of cells of the ordered aperiodic structure.

7. A method according to claim 6 in which the encoded image and its key may have different dimensions.

8. A method according to claim 6 in which matrices of cells of the ordered aperiodic structure are built using the Kronecker product method from basis orthogonal Hadamard matrices of dimension 4×4 or more, in which 50% of elements are equal to +1 and 50% of elements are equal to −1, with the further rearrangement of rows, columns or separate fragments of a matrix of cells for forming different types of encoding structures.

9. A method according to claim 6 in which two-level graphic encoded image is formed using replacement of both levels of the original graphic image with matrix of cells of complementary ordered aperiodic structures of 50% area coverage.

10. A method according to claim 6 in which area coverage of a matrix of cells of the two-level encoded image is reduced by withdrawal of the certain part of dark cells to form enlightened encoded image.

11. A method according to claim 6 in which the three-level graphic encoded image is formed by replacement of two levels of original graphic image with matrix of complementary cells, and the third level of the original graphic image is replaced with matrix of cells of partially complementary ordered aperiodic structure.

12. A method according to claim 6 further including the step of printing, i.e. encoded image is printed on object of protection, and the key of the encoded image is printed inversely on the other side of the protected object, precisely matching the encoded image.

13. A method according to claim 12 in which the encoded image is printed in color inks on the protected object with certain angular orientation.

14. A method according to claim 12 in which the encoded image and its key are printed with resolution which is greater and not multiple to resolution of copiers.

15. A method according to claim 12 in which the encoded image and its key are printed in special color printing inks of two complementary colors.

16. A method according to claim 12 in which the encoded image and its key are printed in special color printing inks of partially complementary colors.

17. A method according to claim 12 in which the encoded image is printed in a color printing ink reflecting light in one of three ranges of visible spectrum, on color background which reflects light in two other ranges of visible spectrum and the key is printed in color or neutral gray ink composed of synthesis colors.

18. A method according to claim 12 in which the encoded image is printed in a color printing ink reflecting light in one of three ranges of visible spectrum on white background and the key is printed in a color ink reflecting light in another range of visible spectrum on white background.

19. A method according to claim 12 in which the encoded image and its key are printed on background of the visible unilateral combined graphic image to form additional elements of the visible image, special marks or symbols for additional protection.

20. A method according to claim 12 in which the encoded image and its key are printed on a background of the visible bilateral combined graphic image to form additional elements of the visible image, special marks or symbols for additional protection.

21. A method according to claim 12 in which the encoded image and its key are printed on a paper with a light watermark which is additionally processed by an agent to increase of its transparency.

22. A method according to claim 12 in which the encoded image and its key are printed on a film.
